(19) United States
(12) Patent Application Publication
(10) Pub. No.: US 2006/0175028 A1
(43) Pub. Date: Aug. 10, 2006

(54) Gate

(76) Inventor: Barry Askinasi, Mt. Sinai, NY (US)

Correspondence Address: DARBY & DARBY P.C., P. O. BOX 5257, NEW YORK, NY, 10150-5257, US

(21) Appl. No.: 11/329,968

(22) Filed: Jan. 10, 2006

Related U.S. Application Data
(60) Provisional application No. 60/643,021, filed on Jan. 11, 2005.

(51) Int. Cl. E06B 3/12

(52) U.S. Cl. 160/225

(57) ABSTRACT

A gate for providing a barrier to an opening comprises a frame which is securable in the opening and a gate attached to the frame and pivotable to open and close the opening. A lock mechanism releasably secures the top and bottom of the gate to the frame and comprises a housing secured to the top of the gate, an operating handle movable vertically with respect to the housing, a latch secured to the handle for releasably engaging the top of said frame, and a locking rod fixed to the operating handle for releasably engaging the bottom of the frame. At least one coil spring is compressed between the operating handle and housing for biasing the operating handle downwardly to a position where the latch engages the top of the frame and the locking rod engages the lower frame member to lock the gate closed.

This application claims priority to U.S. Ser. No. 60/643,021, filed on Jan. 11, 2005. This prior application is incorporated herein by reference.

### FIELD OF INVENTION

The present invention relates generally to a gate for providing a barrier to contain a small child or pet in a certain room or area. More specifically, this invention relates to a gate with a locking mechanism, wherein the locking mechanism has a latch and a locking rod connected to an operating handle for securing the top and bottom of the gate to a frame.

### BACKGROUND OF THE INVENTION

Andersen U.S. Pat. No. 5,890,320 discloses a barrier gate especially for small children. FIG. 3 of the '320 patent shows a locking mechanism for a gate wherein the gate can be locked at both the top and the bottom. The handle 12 is not fixed in relation to the upper portion of the gate and the entire handle, which includes a latch 101 and is attached to a lock bar, must be lifted to unlock the gate. Therefore, because a person must lift the entire handle and not just operate a movable portion thereof, the locking mechanism is not easily operated and may not enable the latch and lock bar to be engaged at relatively the same time.

### SUMMARY OF THE INVENTION

An object of the present invention is provide an improved locking mechanism for a gate.

Another object of the invention is to provide a handle assembly with a latch that does not require lifting the entire assembly from the gate to unlock the gate and is fixed in relation to the upper portion of the gate.

It is a further object of the present invention to provide a locking mechanism for a gate in which the locking rod and latch are engaged in unison.

Still another object of the present invention is to provide a gate having a locking rod wherein the locking rod is not exposed.

The object of the invention is achieved through the use of a locking mechanism comprising a housing secured to a top member of the gate; an operating handle vertically movable with respect to the housing; a latching member secured to the operating handle and movable therewith for releasably engaging a groove in a side member of the frame; and a lock bar fixed to the operating handle and contained in a side member of said gate, the bar being longitudinally moveable by the operating handle for releasably engaging the bottom member of the frame. At least one spring is compressed between the operating handle and the housing for biasing the operating handle downwardly into a position where the latching member engages the groove and the lock bar engages the bottom frame member to lock the gate closed, whereby moving the operating handle upwardly relative to the housing releases both the latching member and the lock bar to enable the gate to be opened.

### BRIEF DESCRIPTION OF THE DRAWINGS

The preferred embodiment of the present invention is described with reference to the attached drawings in which:

FIG. 1 is a perspective view of the gate according to a preferred embodiment of the invention.

FIG. 2 is an exploded perspective view of the locking mechanism according to the preferred embodiment of the invention;

FIG. 3 is a side elevation, partially in section, showing the handle and locking mechanism of the preferred embodiment;

FIG. 4 is a sectional view along the line 4-4 of FIG. 3;

FIG. 5 is a side-sectional view of the handle mechanism;

FIG. 5A is a side elevational view showing the locking mechanism in its unlocked condition;

FIG. 6 is a front elevation, partially in section, illustrating a subsidiary feature of the invention; and

FIG. 7 is a side elevational view, partially in section, showing how the gate is perfectly secured to the frame.

### DETAILED DESCRIPTION OF THE PREFERRED EMBODIMENT

The present invention will be described herein with reference to the drawings which illustrate a preferred embodiment of the present invention. The invention may be embodied in additional forms and the disclosure should not be construed as to exclude these additional embodiments.

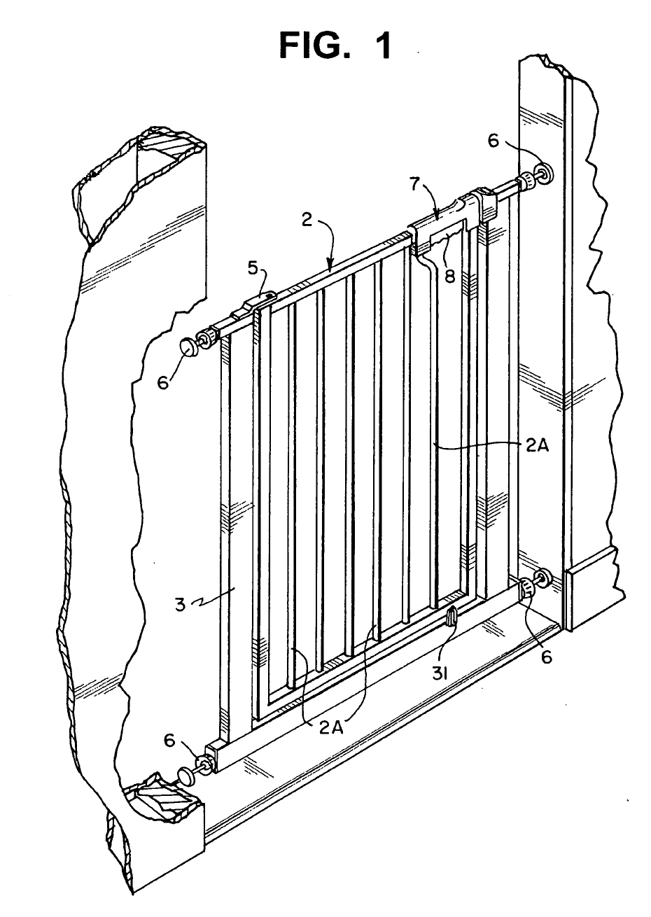

The invention provides an improved gate for providing a barrier to contain a child or pet in a room or area. The gate is preferably placed in an entryway, which may be a doorway. As shown in FIG. 1, a gate 2 is mounted in a frame 3 by gate attachment means 5 and wall supports 6. FIG. 1 also shows the housing 7 and the operating handle 8 of the lock mechanism. In the preferred embodiment, the gate 2 includes bars 2A disposed vertically so as to prevent a pet or child from passing through the gate. However, the present invention is not limited to such an embodiment. One of skill in the art will appreciate the various materials and structures that can comprise the gate to effectively prevent a pet or child from passing through the gate.

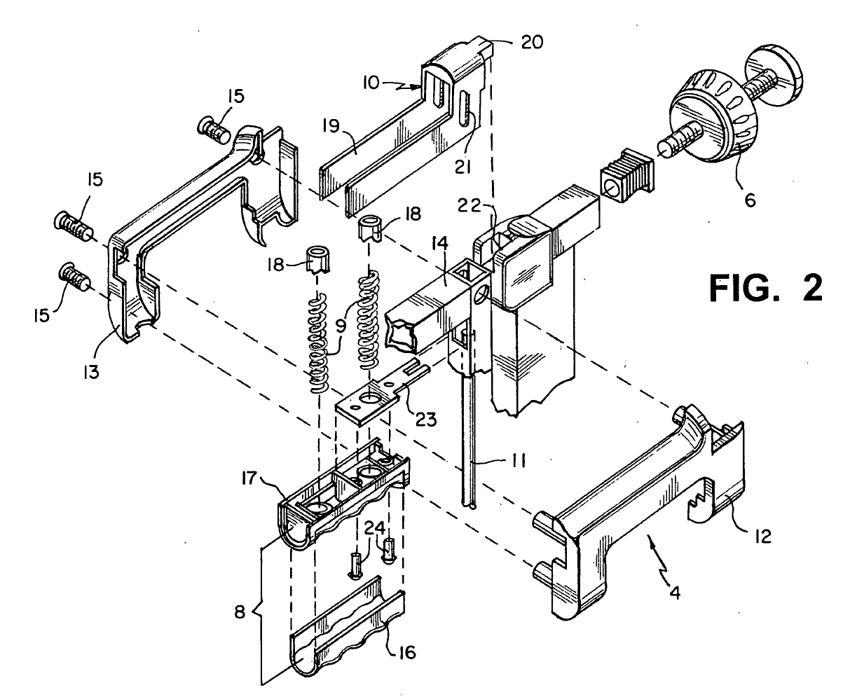

FIG. 2 is an exploded view of a preferred embodiment of the lock mechanism 4. The lock mechanism 4 comprises housing 7, operating handle 8, two springs 9, a latch 10 and a locking rod 11. The housing 7 comprises housing side members 12, 13 disposed on opposite sides of the top member 14 of the gate and attached by screws 15. In the preferred embodiment, housing 7 is slightly curved on the top to accommodate the palm of a human hand.

The operating handle 8 comprises a lower grip member 16 and an upper grip member 17. In the preferred embodiment, the upper grip member 17 has two spring pads disposed on its upper surface and two openings therethrough. Springs 9 bias the operating handle 8 downwardly in relation to the top member of the gate 14 and are disposed vertically between the housing 7 and the upper grip member 17. The springs may be covered with spring caps 18.

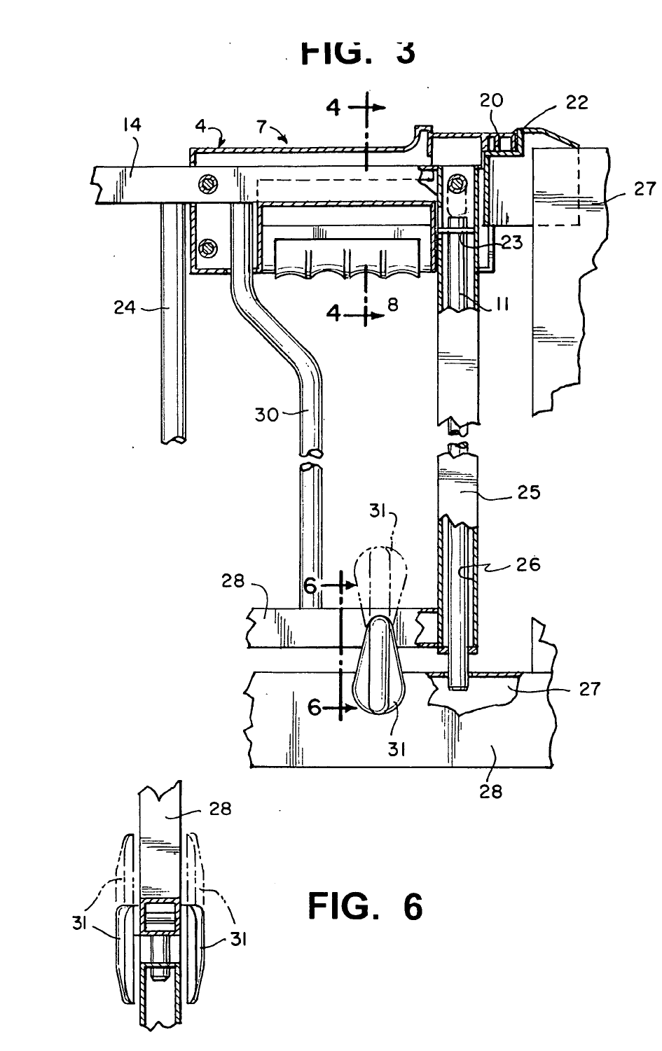

The operating handle 8 is provided with grooves to accommodate human fingers. The operating handle 8 is placed in the housing 7 such that it can comfortably be reached and squeezed by a human hand. The gate 2 is designed so as not to interfere with a hand reaching the operating handle 8. In the preferred embodiment, as shown in FIG. 3, the bar 30 closest to the operating handle 8 is disposed away from the operating handle 8 so as not to interfere with a human hand.

The operating handle 8 is attached to both the latch 10 and the locking rod 11 to lock and unlock the gate 2. The latch 10 locks the upper part of the gate 2 to the frame 3. The latch 10 comprises guide elements 19, a latching member 20 and elongated openings 21. In the preferred embodiment, guide elements 19 are disposed parallel to each other and on both sides of the top member of the gate 14 and between housing side members 12, 13. The guide elements 19 are disposed above the operating handle 8. In the preferred embodiment, the guide members 19 are attached to the operating handle 8. In this position, when the operating handle 8 is biased upwardly the guide members 19 are pushed upwardly. When the lock mechanism 4 is assembled, the elongated openings 21 are disposed on both sides of the top member 14 such that one screw 15 passes through the elongated openings 21. In this position, the latch 10 can move in an upward or downward direction independent of the housing 7. When the latch 10 is biased downwardly, the latching member 20 is lockingly engaged with a groove 22.

Rod attachment plate 23 is fixed to the upper surface of the upper grip member 17 by screws 24 extending through openings on the upper grip member 17. Rod attachment plate 23 is further attached to locking rod 11 such that when the operating handle 8 is moved upwardly the locking rod 11 also moves upwardly. In the preferred embodiment, rod attachment plate 23 includes a forked end and the locking rod 11 has a groove for receiving the forked end of the plate to fix the locking rod to the plate.

FIG. 3 also shows the lock mechanism 4 of the present invention. Locking rod 11 is disposed within the side member 25. An opening for extension of the rod attachment plate 23 to the locking rod 11 is formed on the upper side of the hollow side member 25, as shown in FIG. 2. Locking rod 11 extends through the opening 26 in the side member 25 to lockingly engage the opening 27 in the lower member 28 of the frame. Groove 22 in frame side member 27 enables locking engagement with latching member 20. In the preferred embodiment, gate 1 further comprises a stopper 31 for restricting the direction in which the gate 2 may swing. When locking rod 11 is positioned in the opening 27 in the lower member of the frame, the lower portion of the gate is prevented from lateral movement relative to the frame.

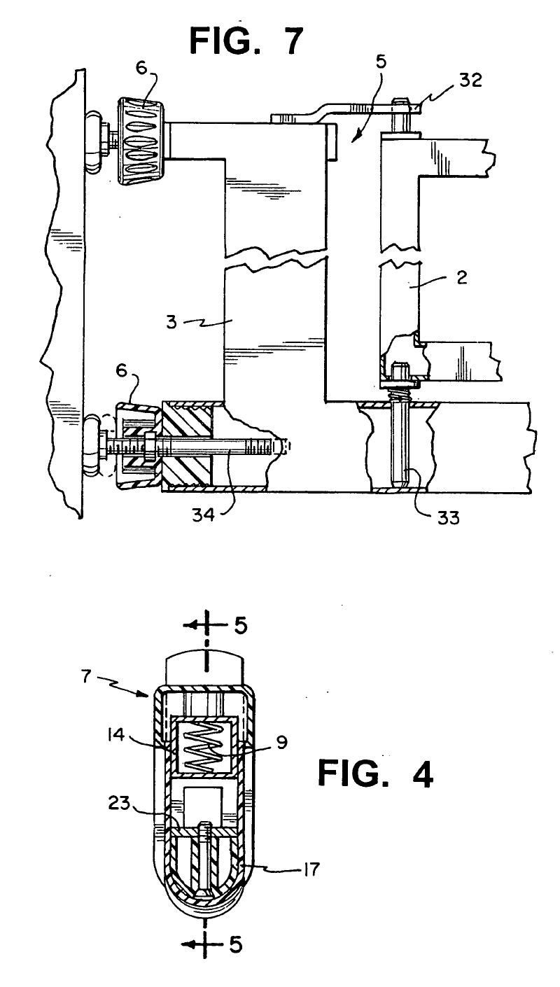

FIG. 4 shows the housing 7, operating handle 8 and springs 9 according to the preferred embodiment of the invention. In the preferred embodiment, springs 9 are disposed vertically between the housing 7 and the upper grip member 17 and pass through the top member 14. Therefore, in the preferred embodiment, the upward movement of the upper grip member 17 is not restricted.

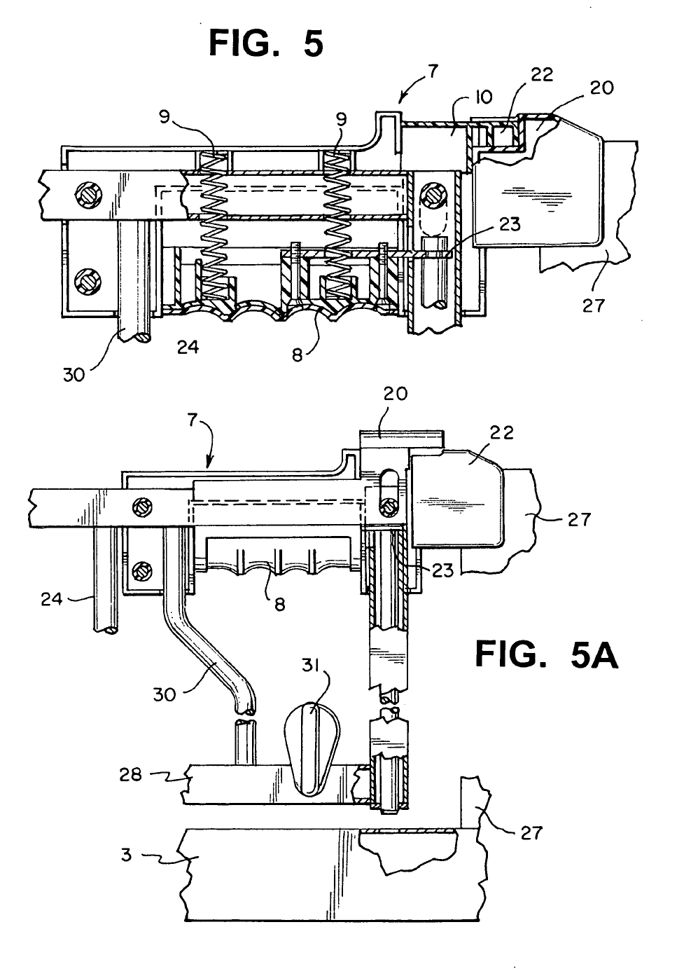

FIG. 5 shows a cross-sectional view at line 5-5 of FIG. 4 of the housing 7 and operating handle 8 according to the preferred embodiment of the present invention, wherein the lock mechanism 4 is biased by springs 9 in the locked position, with latching member 20 lockingly engaged with groove 22 in side member 27.

FIG. 5A shows the assembled lock mechanism according to the preferred embodiment of the present invention, with the lock mechanism 4 in the unlocked position. Latch 10 has been moved upwardly by operating handle 8 such that latching member 20 is lifted above groove 22. Rod attachment plate 23 is moved upwardly by operating handle 8 such that locking rod 11 is not lockingly engaged with opening 27. The gate 2 is thus free to move laterally relative to the frame. In FIG. 5A, stopper 31 is in a position where it does not restrict movement of the gate 2 in relation to the frame 3.

As shown in FIG. 6, two stoppers 31 may be attached to the lower portion of the gate 2 by a pin or other suitable attachment means such that the stoppers 31 can move independently in relation to gate 2. This allows only one stopper 31 to be placed in a downward position at a time to permit the gate 2 to swing laterally in only one direction.

FIG. 7 shows a perspective view of the gate attachment means 5 and wall supports 6 according to the invention. In the preferred embodiment, the gate attachment means 5 comprises a hinge 32 and pin 33 for attaching gate 2 to frame 3. Wall supports 6 are attached to frame 3 by screws 34 or any other suitable means of attachment. Screws 34 allow for the adjustment of the wall supports 6 away from the frame 3 such that the frame 3 can be adjusted for placement in different sized doorways or openings.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

We claim:

1. A gate for providing a barrier to an opening, comprising:
a frame which is securable in the opening and which includes a lower member;
said gate being attached to said frame so as to swing relative to said frame to open and close said opening, said gate having a horizontal top and bottom members and vertical side members;
a lock mechanism for securing the top and bottom of the gate to the frame, said lock mechanism comprising:
a housing secured to the top member of the gate;
an operating handle movable vertically with respect to said housing;
a latch secured to said operating handle and movable therewith for releasably engaging the top of said frame;
a locking rod fixed to the operating handle and moveable therewith for releasably engaging said lower frame member;
at least one coil spring compressed between said operating handle and said housing for biasing the operating handle, downwardly to a position where the latch engages the top of said frame and the locking rod engages the lower frame member to lock the gate closed, whereby movement of the operating handle upwardly pulls both the latch and the locking rod out of engagement with the frame to enable the gate to be opened.

2. A gate according to claim 1, wherein said locking rod extends through one of said gate side members and not through said lower gate member into engagement with the bottom frame member.
